(19) United States
(12) Patent Application Publication
(10) Pub. No.: US 2021/0325722 A1
(43) Pub. Date: Oct. 21, 2021

(54) COLOR FILM SUBSTRATE AND MANUFACTURING METHOD THEREOF

(71) Applicants: HKC CORPORATION LIMITED, GUANGDONG (CN); CHONGQING HKC OPTOELECTRONICS TECHNOLOGY CO., LTD., CHONGQING (CN)

(72) Inventor: Yunqin Hu, Chongqing (CN)

(73) Assignees: HKC CORPORATION LIMITED, GUANGDONG (CN); CHONGQING HKC OPTOELECTRONICS TECHNOLOGY CO., LTD., CHONGQING (CN)

(21) Appl. No.: 16/327,062

(22) PCT Filed: Jul. 19, 2018
(86) PCT No.: PCT/CN2018/096294

§ 371 Date: Feb. 21, 2019

(30) Foreign Application Priority Data
Feb. 26, 2018 (CN) 201810162681.X

(51) Int. Cl. G02F 1/1335

(52) U.S. Cl. CPC G02F 1/133516

(57) ABSTRACT

The color film substrate includes a base substrate and a plurality of pixel units. Each of the pixel units includes a first color resist, a second color resist, a third color resist, and a fourth color resist. The fourth color resist includes a first secondary color resist, a second secondary color resist, and a third secondary color resist. Areas of the first secondary color resist, the second secondary color resist, and the third secondary color resist are equal. The first secondary color resist and the first color resist are made of the same material, the second secondary color resist and the second color resist are made of the same material, and the third secondary color resist and the third color resist are made of the same material.

### TECHNICAL FIELD

Embodiments of the present disclosure relate to display technologies, and more particularly relate to a color film substrate and a manufacturing method thereof.

### BACKGROUND

Principle of RGBW liquid crystal display technology is to add a white sub-pixel (W) sub-pixel to a conventional RGB pixel consisting of a red (R) sub-pixel, a green (G) sub-pixel, and a blue (B) sub-pixel, and then apply corresponding sub-pixel imaging techniques to arrange those sub-pixels accordingly. This can ensure that images that are not visible to the human eye are generated without loss of display power and lightness source. The RGBW pixel design makes the display brighter and higher resolution than the conventional RGB pixel design.

However, in manufacture of the RGBW four-color sub-pixel, it is required to coat four kinds of color resist materials on the base substrate of the color film substrate, thereby causing an increasing cost of the substrate material, and the manufacturing process becomes also complicated.

### SUMMARY

Embodiments of the present disclosure provide a color film substrate and a manufacturing method thereof, thereby saving the manufacturing cost of the color film substrate.

The embodiments of the present disclosure provide a color film substrate, which includes a base substrate and a plurality of pixel units.

The plurality of pixel units are located on the base substrate and arranged in an array. A first side of the array extends along a first direction, and a second side of the matrix extends along a second direction. The first direction is substantially perpendicular to the second direction. Each of the pixel units includes a first color resist, a second color resist, a third color resist, and a fourth color resist. The fourth color resist includes a first secondary color resist, a second secondary color resist, and a third secondary color resist. Areas of the first secondary color resist, the second secondary color resist, and the third secondary color resist are equal. The first secondary color resist and the first color resist are made of a first material, the second secondary color resist and the second color resist are made of a second material, and the third secondary color resist and the third color resist are made of a third material.

The embodiments of the present disclosure provide a color film substrate, which includes a base substrate, an opaque layer made of an opaque material disposed on the base substrate, and a pixel unit.

The opaque layer defines a first opening, a second opening, a third opening, and a fourth opening thereon exposing the base substrate. The fourth opening consists of a first region, a second region, and a third region.

The pixel unit consists of a first color resist, a second color resist, a third color resist, a first sub color resist, a second sub color resist, and a third sub color resist. The first color resist is disposed in the first opening, the second color resist is disposed in the second opening, and the third color resist is disposed in the third opening, the first sub color resist is disposed in the first region of the fourth opening, the second sub color resist is disposed in the second region of the fourth opening, and the third sub color resist is disposed in the third region of the fourth opening.

The first opening, the second opening, the third opening, and the fourth opening are sequentially arranged along a first direction. Areas of the first region, the second region, and the third region of the fourth opening are equal. The first secondary color resist and the first color resist are made of a first material, the second secondary color resist and the second color resist are made of a second material, and the third secondary color resist and the third color resist are made of a third material.

The embodiments of the present disclosure also provide a method of manufacturing the color film substrate, which includes: providing a base substrate; forming an opaque material layer on the base substrate; forming a plurality of sets of openings on the opaque material layer to expose the base substrate, the plurality of openings are arranged in an array, a first side of the array extends along a first direction, a second side of the matrix extends along a second direction, the first direction and the second direction are substantially perpendicular, each of the sets of openings includes a first opening, a second opening, a third opening, and a fourth opening, the first opening, the second opening, the third opening, and the fourth opening are sequentially arranged along the second direction, the fourth opening includes a first region, a second region, and a third region; simultaneously forming a first color resist and a first secondary color resist using a first material in the first opening and the first region of the fourth opening in each of the sets of openings; simultaneously forming a second color resist and a second secondary color resist using a second material in the second opening and the second region of the fourth opening in each of the sets of openings; and simultaneously forming a third color resist and a third secondary color resist using a third material in the third opening and the third region of the fourth opening in each of the sets of openings. Areas of the first region, the second region, and the third region of the fourth opening are equal.

The color film substrate provided by the embodiments of the present disclosure includes the first color resist, the second color resist, the third color resist, and the fourth color resist. The fourth color resist includes a first secondary color resist, a second secondary color resist, and a third secondary color resist. The first secondary color resist and the first color resist are made of the same material, the second secondary color resist and the second color resist are made of the same material, and the third secondary color resist and the third color resist are made of the same material. Illustratively, the first color resist is a red color resist, and an outgoing light passing through the red color resist is red light. The second color resist is a green color resist, and an outgoing light passing through the green color resist is green light. The third color resist is a blue color resist, and an outgoing light passing through the blue color resist is blue light. In the related art, the fourth color resist is a white color resist, and an outgoing light passing through the white color resist is white light. During manufacturing the color film substrate, it is thus required to coat four color resist materials on the base substrate of the color film substrate in the prior art. In one embodiment of the present disclosure, the first secondary color resist is made of the same material as the red color resist, the second secondary color resist is made of the same material as the green color resist, and the third secondary color resist is made of the same material as the blue color resist. The outgoing light passing through the first secondary color resist emits red light, the outgoing light passing through the second secondary color resist emits green light, and the outgoing light passing through the third secondary color resist emits blue light. Since the areas of the first secondary color resist, the second secondary color resist, and the third secondary color resist are equal, an outgoing light after mixing the red light emitted by the outgoing light passing through the first secondary color resist, the green light emitted by the outgoing light passing through the second secondary color resist, and the blue light emitted by the outgoing light passing through the third secondary color resist is white light. During manufacturing the color film substrate, the embodiments of the present disclosure only requires to coat three color resist materials on the base substrate of the color film substrate, thereby achieving the effect of saving the manufacturing cost of the color film substrate.

### BRIEF DESCRIPTION OF THE DRAWINGS

FIG. 1 is a schematic top view of a color film substrate according to an embodiment of the present disclosure.

FIG. 2 is an enlarged view of a region S1 of FIG. 1.

FIG. 3 is another enlarged view of the region S1 of FIG. 1.

FIG. 4 is another enlarged view of the region S1 of FIG. 1.

FIG. 5 is another enlarged view of the region S1 of FIG. 1.

FIG. 6 is another enlarged view of the region S1 of FIG. 1.

FIG. 7 is another enlarged view of the region S1 of FIG. 1.

FIGS. 8 to 11 are schematic views of manufacturing a color film substrate according to an embodiment of the present disclosure.

### DETAILED DESCRIPTION OF THE EMBODIMENTS

The present disclosure are further described more fully hereinafter with reference to the accompanying drawings and embodiments. It will be understood that the specific embodiments described herein are merely illustrative of the present disclosure and not as a limitation of the disclosure. It is also to be noted that, for the convenience of description, only some but not all of the structures related to the present disclosure are shown in the accompanying drawings.

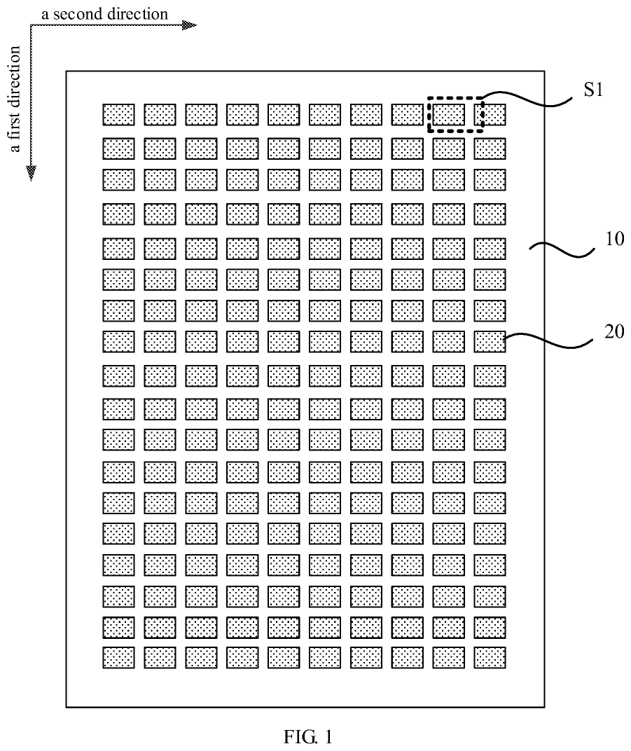

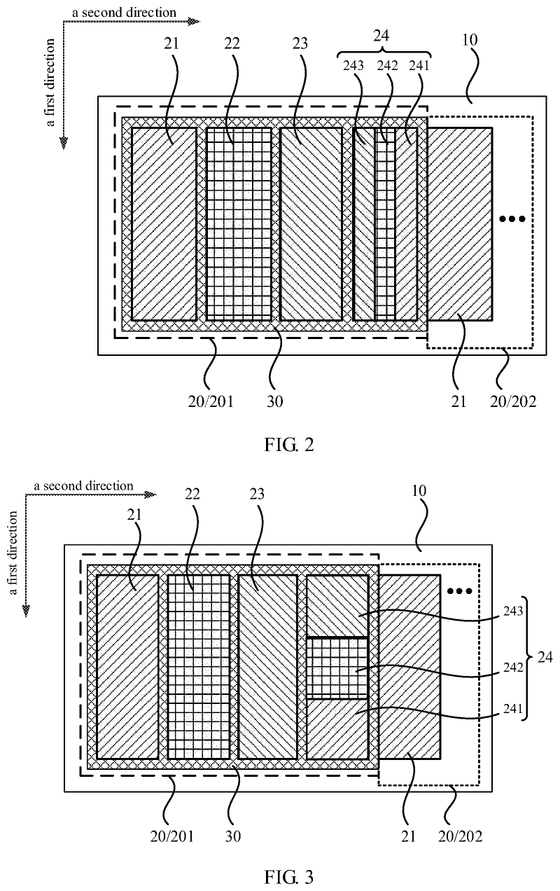

FIG. 1 is a schematic top view of a color film substrate according to an embodiment of the present disclosure, and FIG. 2 is an enlarged view of a region S1 of FIG. 1. Referring to FIG. 1 and FIG. 2, the color film substrate includes a base substrate 10 and a plurality of pixel units 20 located on the base substrate 10. The plurality of pixel units 20 are arranged in an array along a first direction and a second direction. The first direction intersects the second direction. Each of the pixel units 20 includes a first color resist 21, a second color resist 22, a third color resist 23, and a fourth color resist 24. The fourth color resist 24 includes a first secondary color resist 241, a second secondary color resist 242, and a third secondary color resist 243. Areas of the first secondary color resist 241, the second secondary color resist 242, and the third secondary color resist 243 are equal. The first secondary color resist 241 and the first color resist 21 are made of the same material, the second secondary color resist 242 and the second color resist 22 are made of the same material, and the third secondary color resist 243 and the third color resist 23 are made of the same material.

The color film substrate provided by the embodiments of the present disclosure includes the first color resist 21, the second color resist 22, the third color resist 23, and the fourth color resist 24. The fourth color resist 24 includes a first secondary color resist 241, a second secondary color resist 242, and a third secondary color resist 243. The first secondary color resist 241 and the first color resist 21 are made of the same material, the second secondary color resist 242 and the second color resist 22 are made of the same material, and the third secondary color resist 243 and the third color resist 23 are made of the same material. Illustratively, the first color resist 21 is a red color resist, and an outgoing light passing through the red color resist is red light. The second color resist 22 is a green color resist, and an outgoing light passing through the green color resist is green light. The third color resist 23 is a blue color resist, and an outgoing light passing through the blue color resist is blue light. In the related art, the fourth color resist is a white color resist, and an outgoing light passing through the white color resist is white light. During manufacturing the color film substrate, it is thus required to coat four color resist materials on the base substrate of the color film substrate. In one embodiment of the present disclosure, the first color resist 21 is a red color resist, the second color resist 22 is a green color resist, the third color resist 23 is a blue color resist, the first secondary color resist 241 is a red color resist, the second secondary color resist 242 is a green color resist, and the third secondary color resist 243 is a blue color resist. An outgoing light passing through the first secondary color resist 241 emits red light, an outgoing light passing through the second secondary color resist 242 emits green light, and an outgoing light passing through the third secondary color resist 243 emits blue light. Since the areas of the first secondary color resist 241, the second secondary color resist 242, and the third secondary color resist 243 are equal, an outgoing light after mixing the red light emitted by the outgoing light passing through the first secondary color resist 241, the green light emitted by the outgoing light passing through the second secondary color resist 242, and the blue light emitted by the outgoing light passing through the third secondary color resist 243 is white light. During manufacturing the color film substrate, it only requires to coat three color resist materials on the base substrate 10 of the color film substrate, thereby achieving the effect of saving the manufacturing cost of the color film substrate.

Optionally, referring to FIG. 2, the first color resist 21, the second color resist 22, the third color resist 23, and the fourth color resist 24 are each shaped as a rectangle. A direction of long sides of the first color resist 21, the second color resist 22, the third color resist 23, and the fourth color resist 24 extends along the first direction. A direction of short sides of the first color resist 21, the second color resist 22, the third color resist 23, and the fourth color resist 24 extends along the second direction.

Optionally, referring to FIG. 2, in each of the pixel units 20, the first color resist 21, the second color resist 22, the third color resist 23, and the fourth color resist 24 are sequentially arranged along the second direction. In other words, along the second direction, the second color resist 22 is located between the first color resist 21 and the third color resist 23, and the third color resist 23 is located between the second color resist 22 and the fourth color resist 24.

Optionally, referring to FIGS. 1 and 2, the plurality of pixel units 20 are repeatedly arranged along the second direction, and the plurality of pixel units 20 are also repeatedly arranged along the first direction. In general, the plurality of pixel units 20 are arranged in a matrix on the base substrate 10. Illustratively, since the pixel units 20 are repeatedly arranged along the second direction, a first pixel unit 201 is adjacent to a second pixel unit 202, and the fourth color resist 24 in the first pixel unit 201 is adjacent to the first color resist 21 in the second pixel unit 202. It should be noted that, “A is adjacent to B” in the present disclosure means that a distance between A and B is less than a set threshold, and A may be in direct contact with B or there may be other objects between A and B.

Optionally, referring to FIG. 2, the color film substrate further includes a black matrix 30. The black matrix 30 is provided with opening regions distributed in a form of a grid. The first color resist 21, the second color resist 22, the third color resist 23, and the fourth color resist 24 are distributed in the opening regions distributed in the form of the grid (within a gap of the black matrix 30).

Optionally, referring to FIG. 2, the first secondary color resist 241 in the first pixel unit 201 is adjacent to the first color resist 21 in the second pixel unit 202. The first secondary color resist 241 in the first pixel unit 201 is separated from the first color resist 21 in the second pixel unit 202 by the black matrix 30. There is no other color resist or secondary color resist between the first secondary color resist 241 in the first pixel unit 201 and the first color resist 21 in the second pixel unit 202. In addition, a distance between the first secondary color resist 241 in the first pixel unit 201 and the first color resist 21 in the second pixel unit 202 is less than the set threshold. In other words, the first secondary color resist 241 in the first pixel unit 201 is extremely close to the first color resist 21 in the second pixel unit 202. It should be understood that, since the first secondary color resist 241 and the first color resist 21 are made of the same material, and the third secondary color resist 243 and the third color resist 23 are made of the same material, the configuration that each of the first secondary color resists 214 is adjacent to the first color resist 21 in the pixel unit 20 which is in contact with the pixel unit 20 in which the first secondary color resists 214 is located, each of the third secondary color resists 243 is adjacent to the third color resist 23 in the pixel unit 20 in which the third secondary color resist 243 can simplify the patterning process in the process of manufacturing the color film substrate.

The present disclosure provides some embodiments of the shapes of the first secondary color resist, the second secondary color resist, and the third secondary color resist, as well as their distribution in the fourth color resist, but is not intended to limit the present disclosure, and those skilled in the art can derive variations from the embodiments given in the present disclosure.

Referring to FIG. 2, in each of the fourth color resists 24, the first secondary color resist 241, the second secondary color resist 242, and the third secondary color resist 243 are each shaped as a rectangle. A direction of long sides of the first secondary color resist 241, the second secondary color resist 242, and the third secondary color resist 243 extends along the first direction. A direction of short sides of the first secondary color resist 241, the second secondary color resist 242, and the third secondary color resist 243 extends along the second direction. The first secondary color resist 241, the second secondary color resist 242, and the third secondary color resist 243 are sequentially arranged along the second direction. Along the second direction, the second secondary color resist 242 is located between the first secondary color resist 241 and the third secondary color resist 243. The first secondary color resist 241, the second secondary color resist 242, and the third secondary color resist 243 can have the same shape, the same short side length, and the same long side length. A sum of lengths of the short sides of the first secondary color resist 241, the second secondary color resist 242, and the third secondary color resist 243 is equal to a length of the short side of the fourth color resist 24.

FIG. 3 is another enlarged view of the region S1 of FIG. 1. Referring to FIG. 3, in each of the fourth color resists 24, the first secondary color resist 241, the second secondary color resist 242, and the third secondary color resist 243 are each shaped as an orthogon. Optionally, the first secondary color resist 241, the second secondary color resist 242, and the third secondary color resist 243 are each shaped as a square. The first secondary color resist 241, the second secondary color resist 242, and the third secondary color resist 243 are sequentially arranged along the first direction. The second secondary color resist 242 is located between the first secondary color resist 241 and the third secondary color resist 243 along the first direction. A sum of a length of a side of the first secondary color resist 241 parallel to the first direction, a length of a side of the second secondary color resist 242 parallel to the first direction, and a length of a side of the third secondary color resist 243 parallel to the first direction is equal to a length of the long side of the fourth color resist 24.

FIG. 4 is another enlarged view of the region S1 of FIG. 1. Referring to FIG. 4, in each of the fourth color resists 24, the first secondary color resist 241 and the second secondary color resist 242 are each shaped as a rectangle. The direction of the long sides of the first secondary color resist 241 and the second secondary color resist 242 extends along the first direction. The direction of the short sides of the first secondary color resist 241 and the second secondary color resist 242 extends along the second direction. A sum of lengths of the short sides of the first secondary color resist 241 and the second secondary color resist 242 is equal to the length of the short side of the fourth color resist 24. The third secondary color resist 243 is shaped as an orthogon, and optionally, the third secondary color resist 243 is shaped as a square. The first secondary color resist 241 and the second secondary color resist 242 are symmetrically arranged. And a sum of the length of the short side of the first secondary color resist 241 and the length of the short side of the second secondary color resist 242 is equal to a length of a side of the third secondary color resist 243 being in contact with the first secondary color resist 241 and the second secondary color resist 242.

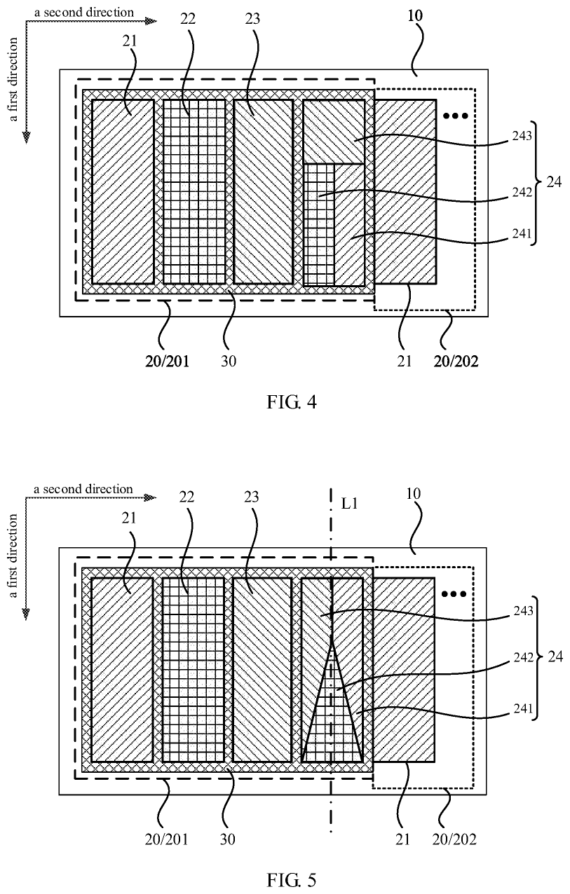

FIG. 5 is another enlarged view of the region S1 of FIG. 1. Referring to FIG. 5, in each of the fourth color resists 24, the first secondary color resist 241 and the third secondary color resist 243 are each shaped as a right-angled trapezoid. The second secondary color resist 242 is shaped as an isosceles triangle. The first secondary color resist 241 and the third secondary color resist 243 are axially symmetrically distributed with respect to a perpendicular bisector L1 of a bottom side of the second secondary color resist 242. The perpendicular bisector L1 of the bottom side of the second secondary color resist 242 extends along the first direction. A sum of bottom sides of the first secondary color resist 241 and the third secondary color resist 243 is equal to the length of the short side of the fourth color resist 24. A length of the bottom side of the second secondary color resist 242 is also equal to the length of the short side of the fourth color resist 24. A length of one right-angle side of the first secondary color resist 241 is equal to the length of the long side of the fourth color resist 24. Similarly, a length of one side of the third secondary color resist 243 which is symmetrically arranged with respect to the first secondary color resist 241 about L1 is equal to the length of the long side of the fourth color resist 24.

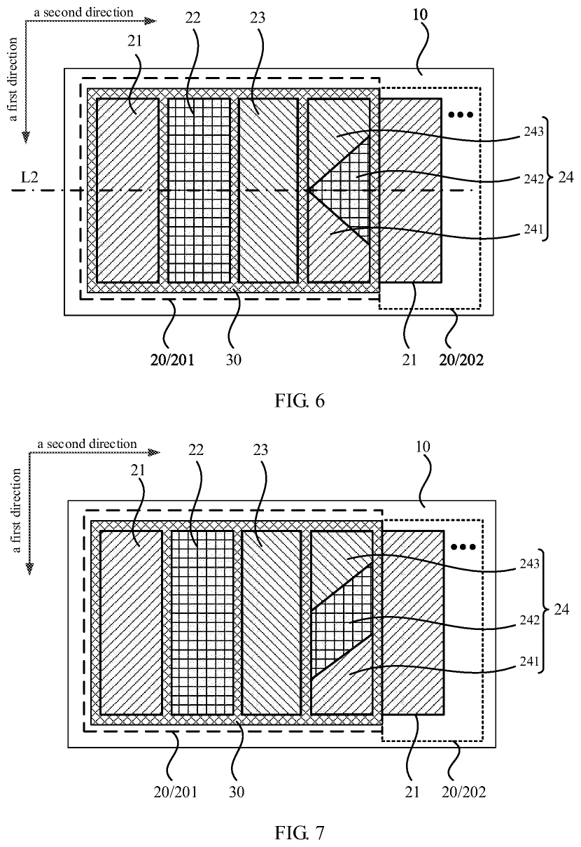

FIG. 6 is another enlarged view of the region S1 of FIG. 1. Referring to FIG. 6, in each of the fourth color resists 24, the first secondary color resist 241 and the third secondary color resist 243 are each shaped as a right-angled trapezoid. The second secondary color resist 242 is shaped as an isosceles triangle. The first secondary color resist 241 and the third secondary color resist 243 are axially symmetrically distributed with respect to a perpendicular bisector L2 of a bottom side of the second secondary color resist 242. The perpendicular bisector L2 of the bottom side of the second secondary color resist 242 extends along the second direction. The lengths of the bottom sides of the first secondary color resist 241 and the third secondary color resist 243 are both equal to the length of the short side of the fourth color resist 24. A height of the second secondary color resist 242 is also equal to the length of the short side of the fourth color resist 24.

FIG. 7 is another enlarged view of the region S1 of FIG. 1. Referring to FIG. 7, in each of the fourth color resists 24, the first secondary color resist 241 and the third secondary color resist 243 are each shaped as a right-angled trapezoid. The second secondary color resist 242 is shaped as a parallelogram. The first secondary color resist 241, the second secondary color resist 242, and the third secondary color resist 243 are sequentially arranged along the first direction. The second secondary color resist 242 is located between the first secondary color resist 241 and the third secondary color resist 243 along the first direction. The lengths of the bottom sides of the first secondary color resist 241 and the third secondary color resist 243 are both equal to the length of the short side of the fourth color resist 24. The first secondary color resist 241 and the third secondary color resist 243 are centrally symmetric with respect to the geometric center of the second secondary color resist 242. The geometric center of the second secondary color resist 242 is an intersection of two diagonal lines thereof.

The present disclosure further provides another color film substrate. The color film substrate includes a base substrate, an opaque layer made of an opaque material disposed on the base substrate, and a pixel unit.

The opaque layer defines a first opening, a second opening, a third opening, and a fourth opening thereon exposing the base substrate. The fourth opening consists of a first region, a second region, and a third region.

The pixel unit consists of a first color resist, a second color resist, a third color resist, a first sub color resist, a second sub color resist, and a third sub color resist. The first color resist is disposed in the first opening, the second color resist is disposed in the second opening, and the third color resist is disposed in the third opening, the first sub color resist is disposed in the first region of the fourth opening, the second sub color resist is disposed in the second region of the fourth opening, and the third sub color resist is disposed in the third region of the fourth opening.

The first opening, the second opening, the third opening, and the fourth opening are sequentially arranged along a first direction. Areas of the first region, the second region, and the third region of the fourth opening are equal. The first secondary color resist and the first color resist are made of a first material, the second secondary color resist and the second color resist are made of a second material, and the third secondary color resist and the third color resist are made of a third material.

In an embodiment, the first opening, the second opening, the third opening, and the fourth opening are orthogonal. The first region, the second region, and the third region of the fourth opening are orthogonal and sequentially arranged along the second direction.

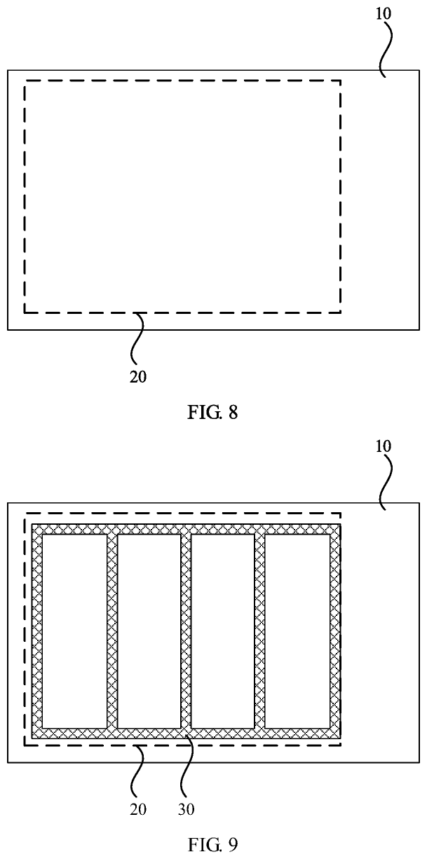

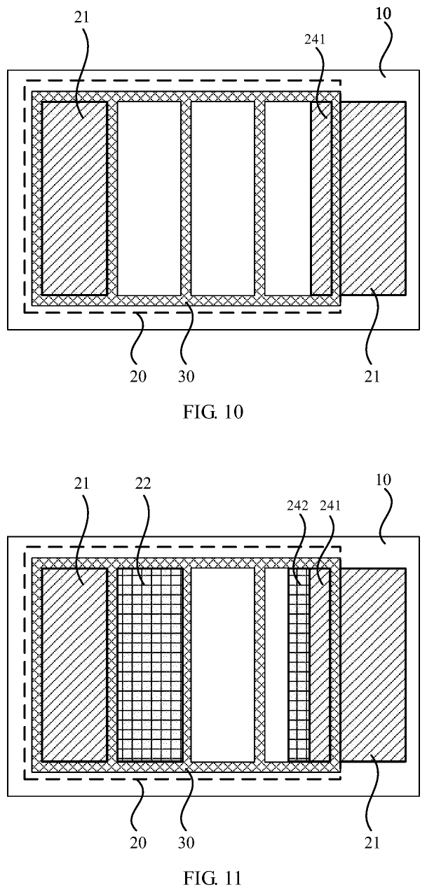

The embodiments of the present disclosure further provides a method of manufacturing the color film substrate. FIGS. 8 to 11 are top views of each stage of the method of manufacturing the color film substrate. Referring to FIGS. 8 to 11 and FIG. 2, the method of manufacturing the color film substrate includes the following steps:

In a first step, a base substrate 10 is provided.

In a second step, a first color resist 21 and a first secondary color resist 241 are simultaneously formed on the base substrate 10 using a first material.

In a third step, a second color resist 22 and a second secondary color resist 242 are simultaneously formed on the base substrate 10 using a second material.

In a fourth step, a third color resist 23 and a third secondary color resist 243 are simultaneously formed on the base substrate 10 using a third material.

The first secondary color resist 241, the second secondary color resist 242, and the third secondary color resist 243 constitute a fourth color resist 24. In addition, areas of the first secondary color resist 241, the second secondary color resist 242, and the third secondary color resist 243 are equal.

In the method of manufacturing the color film substrate provided by the embodiment of the present disclosure, the first secondary color resist 241 and the first color resist 21 are formed using the same material in the same process, the second secondary color resist 242 and the second color resist 22 are formed using the same material in the same process, and the third secondary color resist 243 and the third color resist 23 are formed using the same material in the same process. The first secondary color resist 241, the second secondary color resist 242, and the third secondary color resist 243 constitute the fourth color resist 24. The first color resist 21, the second color resist 22, the third color resist 23, and the fourth color resist 24 constitute one pixel unit 20. The plurality of pixel units 20 can be arranged in an array on the array substrate 10 (FIGS. 8 to 11 illustratively show the fabrication of the partial pixel unit 20). Compared to the related art where four color resist materials are required to be coated on the base substrate 10 of the color film substrate, only three color resist materials are required to be coated on the base substrate 10 of the color film substrate according to the embodiments of the present disclosure, thereby achieving the effect of saving the manufacturing cost of the color film substrate.

Optionally, referring to FIGS. 8 to 11 and FIG. 2, the first color resist 21 is a red color resist, the second color resist 22 is a green color resist, and the third color resist 23 is a blue color resist.

Optionally, referring to FIGS. 8 to 11 and FIG. 2, after the base substrate 10 is provided, a black matrix 30 is formed on the base substrate 10. The black matrix 30 includes a plurality of opening regions, the plurality of opening regions expose the base substrate 10. The first color resist 21, the second color resist 22, the third color resist 23, and the fourth color resist 24 are formed in the plurality of opening regions of the black matrix 30.

Optionally, referring to FIGS. 8 to 11 and FIG. 2, the first secondary color resist 241 of each of the pixel units 20 is adjacent to the first color resist 21 of the adjacent pixel unit 20. Each of the third secondary color resists 243 is adjacent to the third color resist 23 in the same pixel unit 20. The advantage of such arrangement is that the patterning process in the process of manufacturing the color film substrate can be simplified.

The present disclosure further provides another method of manufacturing the color film substrate. Referring to FIGS. 8 to 11, the method of manufacturing the color film substrate includes the following steps:

First, a base substrate 10 is provided.

Then, an opaque material layer 30 is formed on the base substrate 10.

Then, a plurality of sets of openings are formed on the opaque material layer to expose the base substrate 10. The plurality of openings are arranged in an array. A first side of the array extends along a first direction, and a second side of the matrix extends along a second direction. The first direction and the second direction are substantially perpendicular. Each of the sets of openings includes a first opening, a second opening, a third opening, and a fourth opening. The first opening, the second opening, the third opening, and the fourth opening are sequentially arranged along the second direction. The fourth opening includes a first region, a second region, and a third region.

Then, a first color resist 21 and a first secondary color resist 241 are simultaneously formed using a first material in the first opening and the first region of the fourth opening in each of the sets of openings.

Then, a second color resist 22 and a second secondary color resist 242 are simultaneously formed using a second material in the second opening and the second region of the fourth opening in each of the sets of openings.

Then, a third color resist 23 and a third secondary color resist 243 are simultaneously formed using a third material in the third opening and the third region of the fourth opening in each of the sets of openings.

Areas of the first region, the second region, and the third region of the fourth opening are equal.

In one embodiment, in each of the sets of openings, areas of the first opening, the second opening, the third opening, and the fourth opening are equal.

In one embodiment, in the same fourth opening, no opaque material is disposed between the first secondary color resist, the second secondary color resist, and the third secondary color resist.

In one embodiment, along the second direction, each of the first secondary color resists is separated from the corresponding first color resist by the opaque material, each of the third secondary color resists is separated from the corresponding third color resist by the opaque material.

It should be noted that the above are only the preferred embodiments of the present disclosure and the technical principles applied thereto. Persons skilled in the art may understand that, the present disclosure is not limited to the specific embodiments described herein, and that various modifications, adjustments, combinations and substitutions can be made without departing from the scope of the disclosure. Therefore, although the present disclosure has been described in detail by the above embodiments, the present disclosure is not limited to the above embodiments, and various other equivalent embodiments may be included without departing from the scope of the present disclosure, and the scope of the present disclosure is determined by the scope of the appended claims.

1. A color film substrate, comprising:
a base substrate; and
a plurality of pixel units located on the base substrate and arranged in an array, a first side of the array extending along a first direction, a second side of the array extending along a second direction, the first direction intersecting the second direction;
wherein each of the pixel units comprises a first color resist, a second color resist, a third color resist, and a fourth color resist;
the fourth color resist comprises a first secondary color resist, a second secondary color resist, and a third secondary color resist; areas of the first secondary color resist, the second secondary color resist, and the third secondary color resist are equal;
the first secondary color resist and the first color resist are made of a first material, the second secondary color resist and the second color resist are made of a second material, the third secondary color resist and the third color resist are made of a third material.

2. The color film substrate of claim 1, wherein the first color resist, the second color resist, the third color resist, and the fourth color resist are each shaped as a rectangle having long sides and short sides;
a direction of the long sides of the first color resist, the second color resist, the third color resist, and the fourth color resist extends along the first direction; a direction of the short sides of the first color resist, the second color resist, the third color resist, and the fourth color resist extends along the second direction;
in each of the pixel units, the first color resist, the second color resist, the third color resist, and the fourth color resist are sequentially arranged along the second direction.

3. The color film substrate of claim 1, wherein the first secondary color resist in each of the pixel units is adjacent to the first color resist in an adjacent pixel unit;
the third secondary color resist is adjacent to the third color resist in each of the pixel units.

4. The color film substrate of claim 1, wherein in each of the pixel units, the first secondary color resist, the second secondary color resist, and the third secondary color resist are each shaped as a rectangle having long sides and short sides;
a direction of the long sides of the first secondary color resist, the second secondary color resist, and the third secondary color resist extends along the first direction; a direction of the short sides of the first secondary color resist, the second secondary color resist, and the third secondary color resist extends along the second direction;
the first secondary color resist, the second secondary color resist, and the third secondary color resist are sequentially arranged along the second direction.

5. The color film substrate of claim 3, wherein in each of the pixel units, the first secondary color resist, the second secondary color resist, and the third secondary color resist are each shaped as a rectangle having long sides and short sides;
a direction of the long sides of the first secondary color resist, the second secondary color resist, and the third secondary color resist extends along the first direction; a direction of the short sides of the first secondary color resist, the second secondary color resist, and the third secondary color resist extends along the second direction;
the first secondary color resist, the second secondary color resist, and the third secondary color resist are sequentially arranged along the second direction.

6. The color film substrate of claim 1, wherein in each of the pixel units, the first secondary color resist, the second secondary color resist, and the third secondary color resist are each shaped as an orthogon;
the first secondary color resist, the second secondary color resist, and the third secondary color resist are sequentially arranged along the first direction.

7. The color film substrate of claim 3, wherein in each of the pixel units, the first secondary color resist, the second secondary color resist, and the third secondary color resist are each shaped as an orthogon;
the first secondary color resist, the second secondary color resist, and the third secondary color resist are sequentially arranged along the first direction.

8. The color film substrate of claim 1, wherein in each of the pixel units, the first secondary color resist and the second secondary color resist are each shaped as a rectangle having long sides and short sides; a direction of the long sides of the first secondary color resist and the second secondary color resist extends along the first direction; a direction of the short sides of the first secondary color resist and the second secondary color resist extends along the second direction; the third secondary color resist is shaped as an orthogon;
the first secondary color resist and the second secondary color resist are symmetrically arranged, and a sum of a length of the short side of the first secondary color resist and a length of the short side of the second secondary color resist is equal to a length of a side of the third secondary color resist in contact with the first secondary color resist and the second secondary color resist.

9. The color film substrate of claim 3, wherein in each of the pixel units, the first secondary color resist and the second secondary color resist are each shaped as a rectangle having long sides and short sides; a direction of the long sides of the first secondary color resist and the second secondary color resist extends along the first direction; a direction of the short sides of the first secondary color resist and the second secondary color resist extends along the second direction; the third secondary color resist is shaped as an orthogon;
the first secondary color resist and the second secondary color resist are symmetrically arranged, and a sum of a length of the short side of the first secondary color resist and a length of the short side of the second secondary color resist is equal to a length of a side of the third secondary color resist in contact with the first secondary color resist and the second secondary color resist.

10. The color film substrate of claim 1, wherein in each of the pixel units, the first secondary color resist and the third secondary color resist are each shaped as a right-angled trapezoid, the second secondary color resist is shaped as an isosceles triangle;
the first secondary color resist and the third secondary color resist are axially symmetrically distributed with respect to a perpendicular bisector of a bottom side of the second secondary color resist;
the perpendicular bisector of the bottom side of the second secondary color resist extends along the first direction.

11. The color film substrate of claim 3, wherein in each of the pixel units, the first secondary color resist and the third secondary color resist are each shaped as a right-angled trapezoid, the second secondary color resist is shaped as an isosceles triangle;
the first secondary color resist and the third secondary color resist are axially symmetrically distributed with respect to a perpendicular bisector of a bottom side of the second secondary color resist;
the perpendicular bisector of the bottom side of the second secondary color resist extends along the first direction.

12. The color film substrate of claim 1, wherein in each of the pixel units, the first secondary color resist and the third secondary color resist are each shaped as a right-angled trapezoid, the second secondary color resist is shaped as an isosceles triangle;
the first secondary color resist and the third secondary color resist are axially symmetrically distributed with respect to a perpendicular bisector of a bottom side of the second secondary color resist;
the perpendicular bisector of the bottom side of the second secondary color resist extends along the second direction.

13. The color film substrate of claim 3, wherein in each of the pixel units, the first secondary color resist and the third secondary color resist are each shaped as a right-angled trapezoid, the second secondary color resist is shaped as an isosceles triangle;
the first secondary color resist and the third secondary color resist are axially symmetrically distributed with respect to a perpendicular bisector of a bottom side of the second secondary color resist;
the perpendicular bisector of the bottom side of the second secondary color resist extends along the second direction.

14. The color film substrate of claim 1, wherein in each of the pixel units, the first secondary color resist and the third secondary color resist are each shaped as a right-angled trapezoid, the second secondary color resist is shaped as a parallelogram;
the first secondary color resist, the second secondary color resist, and the third secondary color resist are sequentially arranged along the first direction.

15. A color film substrate, comprising:
a base substrate;
an opaque layer made of an opaque material disposed on the base substrate, wherein the opaque layer defines a first opening, a second opening, a third opening, and a fourth opening thereon exposing the base substrate, the fourth opening consists of a first region, a second region, and a third region; and
a pixel unit consisting of a first color resist, a second color resist, a third color resist, a first sub color resist, a second sub color resist, and a third sub color resist, wherein the first color resist is disposed in the first opening, the second color resist is disposed in the second opening, and the third color resist is disposed in the third opening, the first sub color resist is disposed in the first region of the fourth opening, the second sub color resist is disposed in the second region of the fourth opening, and the third sub color resist is disposed in the third region of the fourth opening;
wherein the first opening, the second opening, the third opening, and the fourth opening are sequentially arranged along a first direction, areas of the first region, the second region, and the third region of the fourth opening are equal, the first sub color resist and the first color resist are made of a first material, the second sub color resist and the second color resist are made of a second material, the third sub color resist and the third color resist are made of a third material.

16. The color film substrate of claim 15, wherein the first opening, the second opening, the third opening, and the fourth opening are orthogonal; the first region, the second region, and the third region of the fourth opening are orthogonal and sequentially arranged along a second direction.

17. A method of manufacturing a color film substrate, comprising:
providing a base substrate;
forming an opaque material layer on the base substrate;
forming a plurality of sets of openings on the opaque material layer to expose the base substrate, wherein the plurality of openings are arranged in an array, a first side of the array extends along a first direction, a second side of the matrix array extends along a second direction, the first direction and the second direction are substantially perpendicular; each of the sets of openings comprises a first opening, a second opening, a third opening, and a fourth opening; the first opening, the second opening, the third opening, and the fourth opening are sequentially arranged along the second direction; the fourth opening comprises a first region, a second region, and a third region;
simultaneously forming a first color resist and a first secondary color resist using a first material in the first opening and the first region of the fourth opening in each of the sets of openings;
simultaneously forming a second color resist and a second secondary color resist using a second material in the second opening and the second region of the fourth opening in each of the sets of openings; and
simultaneously forming a third color resist and a third secondary color resist using a third material in the third opening and the third region of the fourth opening in each of the sets of openings;
wherein areas of the first region, the second region, and the third region of the fourth opening are equal.

18. The manufacturing method of claim 17, wherein in each of the sets of openings, areas of the first opening, the second opening, the third opening, and the fourth opening are equal.

19. The manufacturing method of claim 17, wherein in the same fourth opening, no opaque material is disposed between the first secondary color resist, the second secondary color resist, and the third secondary color resist.

20. The manufacturing method of claim 17, wherein along the second direction, each of the first secondary color resists is separated from the corresponding first color resist by the opaque material, each of the third secondary color resists is separated from the corresponding third color resist by the opaque material.
